(19) United States
(12) Patent Application Publication
(10) Pub. No.: US 2026/0244593 A1
(43) Pub. Date: Aug. 20, 2026

(54) ACCELERATORS WITH UNIFIED INTERFACE MANAGEMENT CIRCUIT

(71) Applicant: MEDIATECK INC., Hsinchu City (TW)

(72) Inventors: Chih-Hsiang Hsiao, Hsinchu City (TW); Yen-Hsiang Li, Hsinchu City (TW); Chia-Feng Hsu, Hsinchu City (TW)

(73) Assignee: MEDIATECK INC., Hsinchu City (TW)

(21) Appl. No.: 19/464,512

(22) Filed: Jan. 29, 2026

Related U.S. Application Data
(60) Provisional application No. 63/759,373, filed on Feb. 17, 2025.

(51) Int. Cl. G06F 15/78; G06F 1/28

(52) U.S. Cl. CPC G06F 15/7807; G06F 1/28

(57) ABSTRACT

The present invention provides a system including a first processor, a second processor and a computing circuit. The computing circuit includes a unified interface management circuit and an accelerator, the unified interface management circuit is coupled between the accelerator and the first processor and the second processor, and the unified interface management circuit receives multiple requests from the first processor and the second processor to control the accelerator to execute the multiple requests.

### CROSS REFERENCE TO RELATED APPLICATIONS

This application claims the benefit of U.S. Provisional Application No. 63/759,373, filed on February 17th, 2025. The content of the application is incorporated herein by reference.

### BACKGROUND

With the increasing demand for artificial intelligence (AI) and high-performance computing, modern application processors (APs) or systems on chip (SoC) usually integrate multiple heterogeneous computing units. These include neural processing units (NPU), deep learning accelerators (DLA), or specialized hardware accelerators. In prior art, the control and communication between the central processing unit (CPU) and these accelerators mainly use the following architectures.

The first common method is for the CPU to directly access the registers of the accelerator through a peripheral bus for control. However, when the number of accelerators in the system increases, the control burden on the CPU rises significantly. This can lead to access latency and affect the real-time performance of the entire system.

The second method is to introduce a subsystem or a microcontroller as an intermediary to manage and drive the accelerators. Although this reduces the burden on the CPU, it faces challenges as application scenarios become more complex. When multiple processors compete for multiple accelerators at the same time, the system lacks a unified and efficient resource scheduling mechanism.

Furthermore, in existing architectures, power control and security control are usually scattered across different modules.

When the system needs to switch between different power modes or perform heterogeneous integration across chips, complex hardware wiring and software settings greatly increase development costs and system instability.

Specifically, in cross-chip integration scenarios, the hardware cost and power consumption of the interfaces are too expensive for certain applications. Therefore, it has become an urgent task in chip design to simplify the communication paths between multiple processors and multiple accelerators while maintaining system flexibility, and to achieve unified resource allocation and security management.

### SUMMARY

Therefore, one object of the present invention is to provide a system that places a unified interface management circuit between multiple processors and at least one accelerator, so as to solve the problems in the prior art such as complex control paths, uneven resource allocation, and cumbersome security settings between multiple processors and accelerators.

In one embodiment of the present invention, a system comprising a first processor, a second processor and a computing circuit is disclosed. The computing circuit comprises a unified interface management circuit and an accelerator, the unified interface management circuit is coupled between the accelerator and the first processor and the second processor, and the unified interface management circuit receives multiple requests from the first processor and the second processor to control the accelerator to execute the multiple requests.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a system according to an embodiment of the present invention.

FIG. 2 is a schematic diagram of a system according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to …”. The terms “couple” and “couples” are intended to mean either an indirect or a direct electrical connection. Thus, if a first device couples to a second device, that connection may be through a direct electrical connection, or through an indirect electrical connection via other devices and connections.

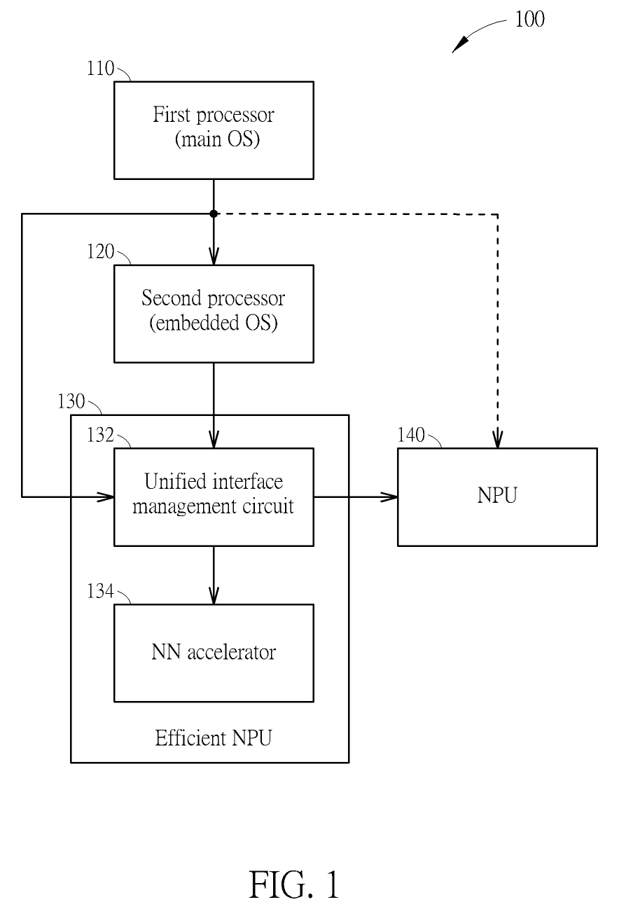

FIG. 1 is a schematic diagram of a system 100 according to an embodiment of the present invention. As shown in FIG. 1, the system 100 includes a first processor 110, a second processor 120, and a plurality of computing circuits. In this embodiment, the computing circuits include an efficient neural processing unit (efficient NPU) 130 and a neural processing unit (NPU) 140. The efficient NPU 130 includes a unified interface management circuit 132 and a neural network (NN) accelerator 134, wherein the NN accelerator may be any type of acceleration circuit, such as a deep learning accelerator (DLA).

In this embodiment, the first processor 110 may be a central processing unit (CPU) configured to execute a main operating system (Main OS) to handle high-load application layer tasks. The second processor 120 may be a microprocessor configured to execute an embedded operating system (Embedded OS) to handle real-time tasks or low-power sensing tasks. The NN accelerator 134 in the efficient NPU 130 is used to perform low-power deep learning operations. The NPU 140 has higher computing power than the NN accelerator 134 and is used to perform more complex or higher-power deep learning operations.

The first processor 110, the second processor 120, the efficient NPU 130, and the NPU 140 may be fabricated on a single system-on-chip (SoC), but the present invention is not limited thereto. In other embodiments, the first processor 110 and the second processor 120 may be fabricated on a first die, while the efficient NPU 130 and the NPU 140 are fabricated on a second die. In another embodiment, the first processor 110, the second processor 120, and the efficient NPU 130 are fabricated on a first die, and the NPU 140 is fabricated on a second die. In yet another embodiment, the first processor 110 and the second processor 120 are on a first die, the efficient NPU 130 is on a second die, and the NPU 140 is on a third die.

In one embodiment, the efficient NPU 130 and the NPU 140 can be fabricated on a single SOC. In another embodiment, the efficient NPU 130 and the NPU 140 and designed with chiplet-based architecture, that is the efficient NPU 130 and the NPU 140 are on different dies. In yet another embodiment, the efficient NPU 130 and the NPU 140 are fabricated on different chips.

Regarding communication interfaces, if all components are within the same chip, control commands and low-latency register access can be handled via an advanced peripheral bus (APB) or other I/O bus interfaces. If the NPU 140 is on a different die from the other components, the unified interface management circuit 132 may connect to it via a peripheral component interconnect express (PCIe) interface, an APB, or another suitable interface.

The unified interface management circuit 132 receives requests/commands from the first processor 110 and the second processor 120 and coordinates the use of the NN accelerator 134 or the NPU 140. Specifically, a front-end interface of the unified interface management circuit 132 monitors requests from the first processor 110 and the second processor 120, and internal security firewalls determine if the requesting OS has permission to access the NN accelerator 134 or the NPU 140. If both the first processor 110 and the second processor 120 request the same resource simultaneously, internal hardware scheduling logic performs arbitration based on a preset priority to ensure stability and reduce the attack surface.

The unified interface management circuit 132 can perform dynamic resource allocation. For example, a low-power request from the second processor 120, such as voice recognition, is directed to the local NN accelerator 134. If the load exceeds the capacity of the NN accelerator 134, or if the first processor 110 issues a complex request like high-definition image processing, the unified interface management circuit 132 directs the task to the NPU 140.

The unified interface management circuit 132 can also manage security, power, and clock settings for the NN accelerator 134 and the NPU 140. This allows the processors to avoid controlling other circuits for these settings, reducing operational complexity and saving power. For instance, the unified interface management circuit 132 can determine to disable or enable the NPU 140 based on processor requests.

In one embodiment, since the first processor 110 is designed to run the main OS and handle high-load application tasks, it will enter a sleep mode under normal states to reduce power consumption.

Because the second processor 120 runs an embedded OS for real-time or low-power sensing tasks, it can remain enabled for a long time or stay on continuously. It stays connected to the unified interface management circuit 132 through independent hardware lines to continue controlling NN accelerator 134 operations. When the NN accelerator 134 is triggered by an event, it reports back through the unified interface management circuit 132 to wake up the first processor 110. For example, in a security monitoring system, the first processor 110 mostly sleeps while the second processor 120 uses the efficient NPU 130 for real-time sound or image detection. If an abnormal event is detected, the unified interface management circuit 132 wakes the first processor 110 for detailed analysis.

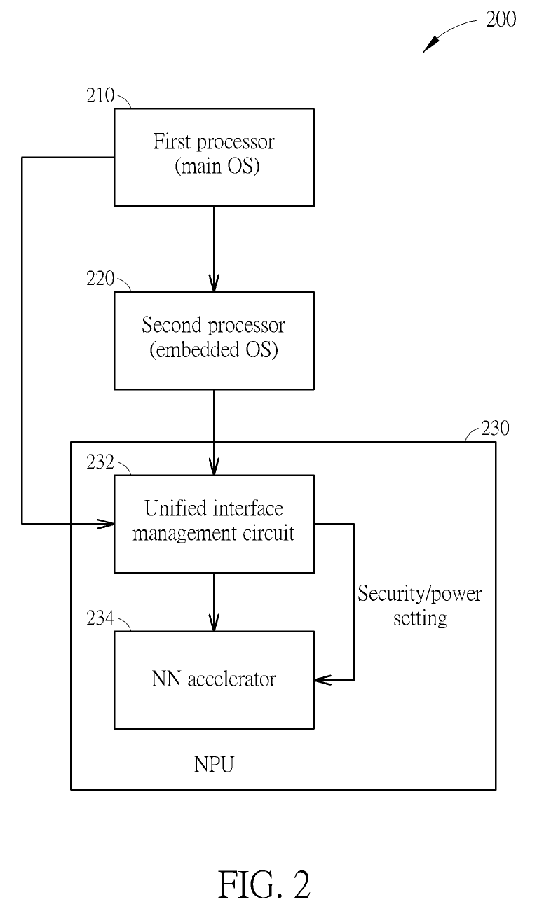

FIG. 2 is a schematic diagram of a system 200 according to an embodiment of the present invention. The system 200 includes a first processor 210, a second processor 220, and a computing circuit, wherein a NPU 230 serves as the computing circuit. The NPU 230 includes a unified interface management circuit 232 and an NN accelerator 234.

In this embodiment, the first processor 210 can be a central processing unit (CPU) that executes a Main OS and handles high-load application tasks. The second processor 220 can be a microprocessor that executes an Embedded OS and handles real-time tasks or low-power sensing tasks. The NN accelerator 234 in the NPU 230 is used to perform deep learning operations.

In this embodiment, the first processor 210, the second processor 220, and the NPU 230 can be fabricated on the same SoC, but the invention is not limited to this. In other embodiments, the first processor 210 and the second processor 220 can be on a first die, while the NPU 230 is on a second die.

Regarding the communication interface of system 200, if all internal components are on the same chip, control commands and low-latency register access can be handled via an APB or other I/O bus interfaces. In one embodiment, if the NPU 230 is on a different die from the first processor 210 and the second processor 220, the unified interface management circuit 232 may connect to them via a PCIe interface, an APB, or another suitable interface.

The unified interface management circuit 232 receives requests/commands from the first processor 210 and the second processor 220 and coordinates the use of the NN accelerator 234. Specifically, a front-end interface of the unified interface management circuit 232 monitors requests from the first processor 210 and the second processor 220, and internal security firewalls determine if the requesting OS has permission to access the NN accelerator 234. If both the first processor 210 and the second processor 220 request the same resource simultaneously, internal hardware scheduling logic performs arbitration based on a preset priority to ensure stability and reduce the attack surface.

The unified interface management circuit 232 can also manage security, power, and clock settings for the NN accelerator 234. This allows the processors to avoid controlling other circuits for these settings, reducing operational complexity and saving power. For instance, the unified interface management circuit 232 can determine to disable or enable the NN accelerator 234 based on processor requests.

In one embodiment, since the first processor 210 is designed to run the Main OS and handle high-load application tasks, it will enter a sleep mode under normal states to reduce power consumption. Because the second processor 220 runs an Embedded OS for real-time or low-power sensing tasks, it can remain enabled for a long time or stay on continuously. It stays connected to the unified interface management circuit 232 through independent hardware lines to continue controlling NN accelerator 234 operations. When the NN accelerator 234 is triggered by an event, it will report back through the unified interface management circuit 232 to wake up the first processor 210.

In summary, by placing a unified interface management circuit between multiple processors and at least one accelerator, the system simplifies control architecture, optimizes dynamic resource scheduling, strengthens security, and reduces power consumption. This solves problems in prior art such as complex control paths, uneven resource allocation, and complicated security settings.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A system, comprising:
a first processor;
a second processor; and
a computing circuit, wherein the computing circuit comprises a unified interface management circuit and an accelerator, the unified interface management circuit is coupled between the accelerator and the first processor and the second processor, and the unified interface management circuit receives multiple requests from the first processor and the second processor to control the accelerator to execute the multiple requests.

2. The system of claim 1, wherein the unified interface management circuit controls security management and power management of the accelerator.

3. The system of claim 1, wherein the first processor and the second processor are on a first die, and the computing circuit is located on a second die.

4. The system of claim 1, wherein the computing circuit is a first computing circuit, and the system further comprises:
a second computing circuit;
wherein the unified interface management circuit receives the multiple requests from the first processor and the second processor to control the accelerator and/or the second computing circuit to execute the multiple requests.

5. The system of claim 4, wherein the unified interface management circuit controls security management and power management of the accelerator and the second computing circuit.

6. The system of claim 4, wherein the first processor, the second processor, the first computing circuit and the second computing circuit are on a same die.

7. The system of claim 4, wherein the first processor, the second processor and the first computing circuit are on a first die, and the second computing circuit is on a second die.

8. The system of claim 4, wherein the first processor and the second processor are located on a first die, the first computing circuit is located on a second die, and the second computing circuit is located on a third die.

9. The system of claim 4, wherein the second processor and the unified interface management circuit are connected via an advanced peripheral bus (APB), the first processor and the unified interface management circuit are connected via the APB or a peripheral component interconnect express (PCIe) interface, and the second computing circuit and the unified interface management circuit are connected via the APB or the PCIe interface.

10. The system of claim 1, wherein the first processor is configured to execute a main operating system to handle high-load tasks, and the second processor is configured to execute an embedded operating system to execute real-time tasks.
